(19) United States
(12) Patent Application Publication
(10) Pub. No.: US 2003/0105730 A1
(43) Pub. Date: Jun. 5, 2003

(54) Postal meters and systems employing watermarking

(76) Inventors: Geoffrey B. Rhoads, West Linn, OR (US); Bruce L. Davis, Lake Oswego, OR (US)

Correspondence Address: DIGIMARC CORPORATION, 19801 SW 72ND AVENUE, SUITE 100, TUALATIN, OR, 97062, US

(21) Appl. No.: 10/244,143

(22) Filed: Sep. 12, 2002

Related U.S. Application Data
(63) Continuation-in-part of application No. 09/343,104, filed on Jun. 29, 1999.
(63) Continuation-in-part of application No. 09/314,648, filed on May 19, 1999.
(63) Continuation-in-part of application No. 09/567,405, filed on May 8, 2000.
(63) Continuation-in-part of application No. 09/629,649, filed on Aug. 1, 2000.
(63) Continuation-in-part of application No. 09/689,289, filed on Oct. 11, 2000.
(60) Provisional application No. 60/323,148, filed on Sep. 17, 2001.

(51) Int. Cl. G07B 17/02

(52) U.S. Cl. 705/407; 305/60

(57) ABSTRACT

Postal meters can print envelopes with indicia that include embedded information. This embedded information can be used for a variety of purposes, including indicating postal value, allowing tamper detection, conveying address or mail sorting/routing information, permitting linking to URLs, conveying public or private messages, creating philatelic collectibles, mail tracking and management, etc. The indicia need not have a utilitarian appearance—postal value and other information can be represented by printing of any form (aesthetic artwork or even tinting) extending over any part of the envelope (or envelope label). Such functionality can be provided using meters at corporate settings, or through equipment available at post offices (e.g., for consumer or USPS use). Desirably, such devices have network connectivity, e.g., to link to databases and exchange information with other systems. The information embedding can take various forms, including but not limited to digital watermarking.

### RELATED APPLICATION DATA

The present application is a non-provisional of application Ser. No. 60/323,148, filed Sep. 17, 2001. This application is also a continuation-in-part of each of the following application Ser Nos.: 09/343,104, filed Jun. 29, 1999; 09/314,648, filed May 19, 1999; 09/567,405, filed May 8, 2000; 09/629,649, filed Aug. 1, 2000; and 09/689,289, filed Oct. 11, 2000.

Digital watermarking technology, including fragile (a.k.a. frail) watermarking, suitable for use in connection with the embodiments detailed below, is detailed in various of the present assignee's prior patents and applications, including U.S. Pat. No. 6,122,403, and application Ser. Nos. 09/498,223, 09/503,881, 09/562,516, 09/625,577, 09/630,243, 09/645,779, 09/689,226, 09/689,293, 09/840,016 (published as U.S. Pat. No. 20,020,054,355), 09/731,456 (including application Ser. No. 60/232,163 incorporated therein), and 10/052,895 (including application Ser. No. 60/263,987 incorporated therein).

The MediaBridge technology referenced herein, by which digitally watermarked documents and objects can trigger customized computer responses, including web browser direction, is detailed, e.g., in application Ser. No. 09/571,422, filed May 15, 2000 (and now published as WO 0070585).

### BACKGROUND AND SUMMARY OF THE INVENTION

As disclosed in the cited applications, digital watermark technology finds many applications in connection with paper mail and postage.

In accordance with one aspect of the invention, a postal metering device is a networked computer with high quality printing capabilities that permits printing over the full face of an envelope (or other substrate/packaging), on one side or both (or all). The meter is arranged to print arbitrary patterning or artwork that is watermarked to convey a postal value. No longer must a printed postal mark have a strictly utilitarian look—the postal value can be represented by printing of any form.

The postal artwork need not be limited to the upper right hand corner of an envelope. It can extend over some or all of the envelope—both front and/or back. In some embodiments, only certain regions of the printed artwork convey the postal watermark information. Others regions can convey different watermark information or none. The artwork may be for aesthetic purposes, or may convey advertising or other promotional images and messages. As with postal meter tape, the artwork can be applied to an adhesive-backed medium that is affixed to an envelope, or can be applied directly to the envelope.

Moreover, the printing need not take the form of artwork. It can take any form—even tinting of the substrate by a seemingly random and/or uniform thin spray of ink jet droplets. Such a printed pattern may appear to human observers as uniform, but when corresponding scan data is analyzed, slight variations in hue, saturation, tone, density, luminosity, or other metric can be discerned and decoded to yield the postal watermark payload.

The pattern applied by the meter's printer can have a security function, e.g., allowing tampering to be detected. This security pattern can be a frail or robust steganographic watermark that is supplemental to, or integral with, the postal watermark. Or the security pattern can have no data-carrying function, and may be applied irrespective of any postal watermark.

The meter can apply a watermark containing address information, permitting compliant devices to sense the address and take corresponding action. One type of address is a delivery or return address, enabling automated mail handling equipment to route (or return) mail to the appropriate destination.

Another type of address is an electronic address, which may be associated with the sender or receiver of the mail, or with another entity. One example of an electronic address is a URL, specifying an address on the Internet. When presented to a computer equipped with an image sensor, network connectivity, and suitable software, an envelope printed with such a watermark can cause the computer to load the web page at the specified URL. Another example of an electronic address is a database record ID. When presented to such a computer, an envelope printed with such a watermark initiates a series of actions in which the computer queries a database with the ID to obtain a corresponding URL, and then loads the web page at that URL. Such functionality, available in Digimarc MediaBridge product offerings from the present assignee, is more fully detailed in copending application Ser. No. 09/571,422.

Direct marketers and others can print patterns on their mailings that convey both a traditional visual impression (e.g., a textual message “Donate Blood, Call the Red Cross Today”) and an encoded address that serves to link to a related or different on-line marketing campaign. A single article of mail can thus serve both technically inexperienced and technically sophisticated recipients, with no marginal costs added by catering to two classes of recipients instead of just one.

The pattern can also convey messages—public or private. Public messages can be conveyed using published formats, decodable using generally available software. Private messages, e.g., encoded according to a proprietary format, or with an encryption key, may be readable only by a recipient who has the necessary software/information.

Meters of the sort discussed above can be provided at the premises of postal users (e.g., homes and offices), and can also be provided at postal offices and other mailing centers.

Systems that combine weigh-stations with printing systems can both weigh a postal article, and then print a pattern that serves as a postal stamp of the correct denomination—given the article's weight and desired service of mail delivery (and optionally other parameters, e.g., zip code of destination). Large scale material handling systems, with conveyor belts and wide aperture ink-spray nozzle arrays, can process large volumes of mail—weighing and applying correct postage to articles moving at high speeds. Such systems can be distinct from mail sorting equipment used by postal services, or can be integrated into such systems.

Through use of such technology, post offices may be relieved of the burden of maintaining inventories of adhesive postal stamps. Their use will be philatelic only, and even this need may largely be supplanted by watermark-encoded postal indicia. Indeed, such indicia can offer collectors attributes that have no counterpart in conventional philately. For example, in addition to the encoded postal value and other information, such indicia may be encoded with consecutive serial numbers, thus permitting one lucky collector to have the first printing of a given postal indicia—a one of a kind item. On the first day of issue for a new indicia, collectors may queue at postal windows for the right to be first in line. A peer-based network may allocate serial numbers to different postal offices on demand—in a random manner when a new indicia is first released—providing collectors equal chances of obtaining indicia #1, regardless of whether they are in Manhattan N.Y. or Manhattan Kans.

The printed indicia may additionally, or alternatively, be encoded with data indicating the place of issuance, further enhancing collectability. If indicia are encoded with both serial number and place of issue data, each postal office can distribute an indicia with serial number 1.

By eliminating physical postage stamps, with the attendant operations of printing, transporting, providing secure inventory space, etc., costs can be reduced and security can be increased.

Desirably, but not necessarily, postal meters as detailed above are provided with on-line connectivity. This connectivity can serve various purposes. One is to link—with other such meters—to one or more common (perhaps distributed) databases from which information can be retrieved, e.g., postal mailing rates, zip code information, artwork and other pattern data, security keys, Digimarc MediaBridge address information and other watermark payloads, etc. Another purpose is to transmit information from the meters for central storage or use by other systems. Such information includes meter activity log data, both for user billing and postal traffic management purposes.

To illustrate one example, a direct mail marketer may employ Digimarc MediaBridge-like markings on mailings to permit recipients to link to on-line web sites. The marketer may want the web site customized according to zip code, so that recipients in different localities link to different web pages. The postal meter used in such a mailing can be arranged to request that the central database issue a unique watermark identifier for each different zip code. For each such identifier, the postal meter can specify (for storage in the database) a corresponding web site to which that identifier should link (e.g., the meter may specify that the identifier used with recipients in zip code 97221 should cause them to link to www.acme.com/fallpromo/97221.html, etc.). The meter can then vary the watermark pattern applied to each item of mail to encode the watermark identifier corresponding to their zip code. In such embodiments, the postal meter is not just a postage-issuing tool, but rather a central element of a sophisticated marketing campaign.

Linked to the same, or related databases, may be pattern reading equipment. Such equipment may be installed at postal offices (e.g., mail handling/sorting equipment) or at user premises. As detailed in the cited applications, such reading equipment can include a 1D or 2D image scanner array (e.g., CMOS or CCD, as commonly incorporated into web cams, scanners etc.) to generate input scan data, and a software or hardware system for processing the scan data to extract the encoded data, check for authenticity, etc. Such devices further may include a modem, network card, or other on-line interface to connect to remote resources such as the shared database noted above. Dedicated reader devices can be used, or systems with more general functionality (e.g., a home PC equipped with a web cam) may be employed.

Large scale readers can include extended optical sensor arrays, e.g., traversing a conveyor that conveys packages. Several such arrays can be employed, e.g., to view articles on the conveyor from top, left, and right side.

The encoded data extracted by the reading equipment can be passed to the remote database for a variety of purposes. One is to link, through the Digimarc MediaBridge service, to a web site associated with the mailing. Another is to confirm that the article of mail has been processed (e.g., sorters may log passage of an envelope at each station and post office it passes through). The recipient may confirm delivery of an article of mail by showing it to a reading station.

In simpler embodiments, many of these on-line functions can be accomplished through use of a data store that is not shared with other users and/or not remote and accessed through on-line connectivity.

In some embodiments, post offices may encode an article of mail with a Digimarc MediaBridge-like identifier in exchange for a slight surcharge over the normal postal rate. The purchaser of such service may be given the option, e.g., through a kiosk at a post office or through an on-line service previously or later accessed, to specify or design a web site to which the article of mail should link.

Mail can be marked, in accordance with the present invention, in manners designed to facilitate physical mail management, both by postal authorities and by recipients who deal with large volumes of mail, e.g., utilities, certain companies, etc. For example, cartons and other shipping containers may be sprayed on all sides with patterns indicating, e.g., the destination zip code and other attribute information. Utility bills may be sent with pre-addressed envelopes that are pre-encoded with the customer's name, invoice number, bill amount, due date, etc. Automated equipment in the utility mailroom can use this data in sorting and processing of the incoming mail.

Data captured during mail handling and sorting information can be channeled and utilized throughout a company or other enterprise, often before the mail has been opened. The data may be acquired within the company's mailroom, or may be collected during handling by the postal service, and electronically forwarded to the company. Thus, for example, all the mail sent to a car company's consumer complaint address can be profiled, e.g., as to originating zip code, so as to permit geographical areas of increased consumer complaints to be more readily identified.

It will be recognized that the term “postal meter” has traditionally referred to a dedicated device that has no functionality other than issuing postage. In accordance with certain embodiments of the present invention, however, it should be recognized that a postal meter can also encompass a general purpose computer system, e.g., with familiar CPU, memory, RAM, disk storage, operating system, applications program, display, keyboard, graphical or other user interface, etc., and printing capabilities. Software run on such system can perform the functions detailed above, in addition to other, non-postal related functions. (The software need not all be permanently resident at the meter—some or all can be downloaded from a remote, on-line resource, as needed to perform the necessary functions. Alternatively, much of the software functionality (e.g., encoding a desired watermark payload in artwork) can be implemented by passing certain data to a remote computer (e.g., passing the watermark payload to a shared server computer), and receiving back from the remote computer intermediate data (e.g., a tile of a bit-mapped encoded pattern) or final data (e.g., printer driver commands specific to the particular printer used).

Having described an illustrated the principles of our invention with reference to specific embodiments, it will be recognized that the principles thereof can be implemented in many other, different, forms.

For example, although traditional printing systems use, e.g., black, cyan, magenta and/or yellow inks, it will be recognized that various advantages can be obtained by using other types of ink in systems according to the present invention—alone or in combination with traditional inks. Magnetic inks and inks that have unusual spectral properties (e.g., fluorescent, infrared or ultraviolet inks) are examples. In such cases, the reading systems used to decode the printing should have complementary capabilities, e.g., scanning with infrared light instead of the visible light used in traditional image capture devices. (Such specialty inks are more particularly considered in application Ser. No. 09/562,516.)

Likewise, while the foregoing description focused on printed indicia bearing steganographic digital watermarks, the indicia may be formed by other means (e.g., texturing), and may be encoded using non-steganographic technologies.

Still further, it will be recognized that a pattern serving several functions and conveying various types of data (e.g., a security pattern, with internet-linking and serial number data encoded) can naturally be used, instead of a pattern serving just one function.

Yet further, it will be recognized that the postal meter can include a weigh station that provides weight data to the meter's processor, so that the correct amount of postage for a given article of mail can be determined. Alternatively, such a weigh station need not form part of the meter per se, but the meter can receive weight data from external sources, e.g., a keypad operated by a user.

To provide a comprehensive disclosure without unduly lengthening this specification, applicants incorporate by reference the disclosures of the patents and patent applications listed above.

The particular combinations of elements and features in the above-detailed embodiments are exemplary only; the interchanging and use of these teachings in combination with the methods and systems detailed in the incorporated-by-reference applications are also contemplated. Indeed, many of the concepts referenced here are more fully detailed—in other contexts—in the cited applications. Further, the principles newly introduced in this disclosure likewise have applicability in the systems detailed in the cited applications.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

We claim

1. A method of operating a postal meter comprising:
weighing an article of postal mail using a scale that provides weight data to the meter;
in a processing unit of said meter, determining a postal charge corresponding to said weight;
using a printing device associated with said meter, printing on the article a pattern having auxiliary information steganographically encoded therein, said auxiliary information representing at least two of the following: zip code of recipient, zip code of sender, postal charge, an identifier for use in internet linking, a serial number, and place of posting.

2. An article of postal mail having a printed postal indicia thereon, said indicia steganographically encoding data representing postage.

3. The article of claim 2 in which said printing is with an infrared, ultraviolet, or magnetic ink.

4. The article of claim 2 in which the indicia is steganographically encoded with a number indicating the rank of said indicia in a sequence of such indicia, wherein collectors can determine which of two postal indicia was first.
